(19) United States
(12) Patent Application Publication
(10) Pub. No.: US 2019/0145432 A1
(43) Pub. Date: May 16, 2019

(54) HYDRAULIC ACTUATOR, ROBOT ARM, ROBOT HAND AND OPERATING METHOD

(71) Applicants: Georg Bachmaier, München (DE); Iason Vittorias, München (DE); Wolfgang Zöls, München-Lochhausen (DE)

(72) Inventors: Georg Bachmaier, München (DE); Iason Vittorias, München (DE); Wolfgang Zöls, München-Lochhausen (DE)

(21) Appl. No.: 16/089,731

(22) PCT Filed: Mar. 27, 2017
(86) PCT No.: PCT/EP2017/057176

§ 371 Date: Jan. 10, 2019

(30) Foreign Application Priority Data
Mar. 31, 2016 (DE) 10 2016 205 275.6

(51) Int. Cl. F15B 7/00; F15B 7/08; B25J 9/00

(52) U.S. Cl. CPC F15B 7/003; B25J 9/0009; F15B 7/08

(57) ABSTRACT

The hydraulic actuator comprises a hydraulic drive cylinder, a first hydraulic output cylinder which is hydraulically coupled to the drive cylinder, and a pressure valve which limits the pressure on the output limiting cylinder depending on an action time of a force on the drive cylinder and/or output piston, wherein the pressure limiting valve is arranged opposite a second output cylinder for limiting pressure and/or in a second output cylinder for relieving pressure, and wherein the second output cylinder is hydraulically coupled to the drive cylinder. The method is a method for operating such a hydraulic actuator, wherein the drive actuator is deflected with deflections having a deflection duration at a deflection frequency for the duration of an acting or a non-acting phase of the hydraulic actuator, wherein the deflection duration defines a movement stiffness of the hydraulic actuator and the deflection frequency defines the resulting deflection speed of the hydraulic actuator.

### CROSS REFERENCE TO RELATED APPLICATIONS

The present patent document is a § 371 nationalization of PCT Application Serial Number PCT/EP2017/057176, filed Mar. 27, 2017, designating the United States which is hereby incorporated by reference in its entirety. This patent document also claims the benefit of DE 102016205275.6 filed Mar. 31, 2016 which is also incorporated by reference in its entirety.

### FIELD

Embodiments relate to a hydraulic actuator, a robot arm, a robot hand, and to an operating method.

### BACKGROUND

A higher flexibility of the conventional automation in machinery is targeted for example in the context of “Industry 4.0”. “soft roboting” has recently gained importance. Robots in manufacturing are intended to collaborate directly with humans. Actuators that include a variable rigidity and a small mass are the prerequisites therefor. Muscles of the human body that may pretension and thus increase the rigidity depending on the application are role models for such actuators. From DE 102014214977 it is known for the functionalities of human muscles to be replicated hydraulically by way of a high force density. To this end, fluid is transmitted from a drive bellows to an output bellows. A reservoir herein equalizes the fluid balance.

Nevertheless, known solutions for actively controlling robot arms or robot hands require a large installation space and are cost intensive.

### BRIEF SUMMARY AND DESCRIPTION

The scope of the present disclosure is defined solely by the appended claims and is not affected to any degree by the statements within this summary. The present embodiments may obviate one or more of the drawbacks or limitations in the related art.

Embodiments provide an actuator and a method for operating the actuator. Furthermore, embodiments provide an improved robot arm and an improved robot hand. The actuator and the method permit an active activation of robot arms and robot hands and at the same time be implementable by way of a reduced installation space and in a cost-effective manner.

The hydraulic actuator includes a hydraulic drive cylinder. The hydraulic drive cylinder includes a drive piston, a first hydraulic output cylinder that is hydraulically linked to the drive cylinder, as well as a pressure limiting valve that depending on an action time of a force on the drive cylinder and/or the drive piston in terms of pressure limits the output cylinder. The pressure limiting valve is disposed for limiting pressure in relation to a second output cylinder and/or for relieving pressure into a second output cylinder. The second output cylinder is hydraulically linked to the drive cylinder.

Using the hydraulic actuator, the pressure limiting valve may be controlled by the action time of the force on the drive piston. The pressure limiting valve that in terms of pressure limits the first output cylinder, by virtue of the pressure limitation sets the rigidity of the hydraulic actuator. Consequently, the rigidity of the hydraulic actuator may be set by the action time of a force on the drive piston, and a human muscle may thus be replicated.

The second output cylinder forms a further actuator that, interacting with the first output cylinder, may cover mutually opposed directions of a degree of freedom. In this way, it is not necessary for in each case one actuator to be provided for the two mutually opposed directions. An actuator that is intended to cover two mutually opposed directions may be implemented by way of a smaller installation space and by way of lower costs.

The pressure limiting valve of the hydraulic actuator, depending on the operating state, is configured for limiting pressure at least temporarily in relation to the second output cylinder, or for relieving pressure into the second output cylinder, e.g. that the pressure limiting valve for limiting pressure is configured in at least one operational state, and for relieving pressure is configured in at least one further operational state.

For the hydraulic actuator, the first output cylinder by way of a first pretensioned stop valve may be linked to the drive cylinder, and the second output cylinder by way of a second pretensioned stop valve may be linked to the drive cylinder. The first stop valve and the second stop valve in relation to the drive cylinder have opposite blocking directions. “Mutually opposite blocking directions in relation to the drive cylinder” refers to when the first stop valve includes a blocking direction that is directed toward the drive cylinder, while the second stop valve includes a blocking direction that is directed away from the drive cylinder, or vice versa.

For the hydraulic actuator, the first and the second output cylinder may be hydraulically linked collectively to the remaining part of the hydraulic actuator by in each case one multi-port valve. Using switching the multi-port valve, the roles of the first actuator and of the reservoir of the known solution mentioned at the outset may be swapped; e.g. that the second output cylinder in a first position of the multi-port valve assumes the role of a reservoir, while the first output cylinder in a second position of the multi-port valve assumes the role of a reservoir.

The hydraulic actuator may include a drive actuator that in terms of motion is linked to the drive cylinder or to the drive piston. The drive actuator may be a piezo actuator or an electro-dynamic or an electro-magnetic actuator. The hydraulic actuator is expediently electrically controllable. The hydraulic actuator may be a piezo actuator or an electro-dynamic actuator or an electro-magnetic actuator. Such an actuator may be electrically controlled in an easy manner.

In an embodiment of hydraulic actuator, the drive cylinder by way of a stop valve and of a first throttle is hydraulically linked to a pretension volume that is located in a pretension hydraulic cylinder, including a pretension piston. The pretension hydraulic cylinder or the pretension piston represents the pressure limiting valve. The pretension volume, that by pretension piston actuates the pressure limiting valve by way of the stop valve and the throttle, may be set hydraulically in a simple manner by the action time of a force on the drive piston.

In the case of the hydraulic actuator the pretension volume by way of a second throttle is expediently hydraulically connected to the second output cylinder. In this way, the pretension volume in the event of a corresponding action time may be fed from the second output cylinder or be discharged into the second output cylinder.

In an embodiment of the hydraulic actuator, the pressure limiting valve is configured for limiting pressure in relation to the second output cylinder or for relieving pressure into the second output cylinder. The first output cylinder in the case of a low rigidity of the hydraulic actuator may relieve pressure into the second output cylinder or, depending on the position of the pressure limiting valve, may maintain a high rigidity.

In an embodiment, for the hydraulic actuator, a first output piston is guided in the first output cylinder, and/or a second output piston is guided in the second output cylinder. The first output piston and the second output piston function as active elements of the hydraulic actuator. Alternatively, the first and/or the second output cylinder are in each case formed by way of a bellows such that at least part of the first and/or of the second output cylinder form/forms the active elements of the hydraulic actuator.

In an embodiment of hydraulic actuator, the first output cylinder by way of a pretensioned stop valve is linked to the drive cylinder. A driving action of the drive cylinder or of the drive piston may be transmitted in the event of a sufficient pressure differential between the drive cylinder and the first output cylinder. However, depending on the pressure conditions, the driving action may also be set back without any direct consequence for the first output cylinder, such that a large linear stroke by the first output cylinder is achieved as a result of a periodic movement of the drive cylinder or of the drive piston, for example.

Embodiments provide a robot arm or robot hand that includes at least one hydraulic actuator as described above.

Embodiments further provide a method for operating a hydraulic actuator or a robot arm or a robot hand as described above. The drive actuator for the duration of an operative or non-operative phase of the hydraulic actuator including deflections is deflected for a deflection duration at a deflection frequency. The deflection duration establishes a motional rigidity of the hydraulic actuator, and the deflection frequency establishes the resulting deflection velocity of the hydraulic actuator.

The drive actuator may be electrically controllable, for example as a piezo actuator or an electro-dynamic actuator or an electro-magnetic actuator.

In one further embodiment, the hydraulic drive cylinder and/or the first and/or the second hydraulic output cylinder and/or the pretension hydraulic cylinder are/is in each case formed by way of one bellows.

### FIGURES

FIG. 1 schematically depicts a known hydraulic actuator in a hydraulic block diagram;

FIG. 2 schematically depicts three operating modes (a), (b), and (c) of the hydraulic actuator according to FIG. 1, in a diagrammatic illustration; and

FIG. 3 schematically depicts a hydraulic actuator according to an embodiment including a first and a second output cylinder.

### DESCRIPTION

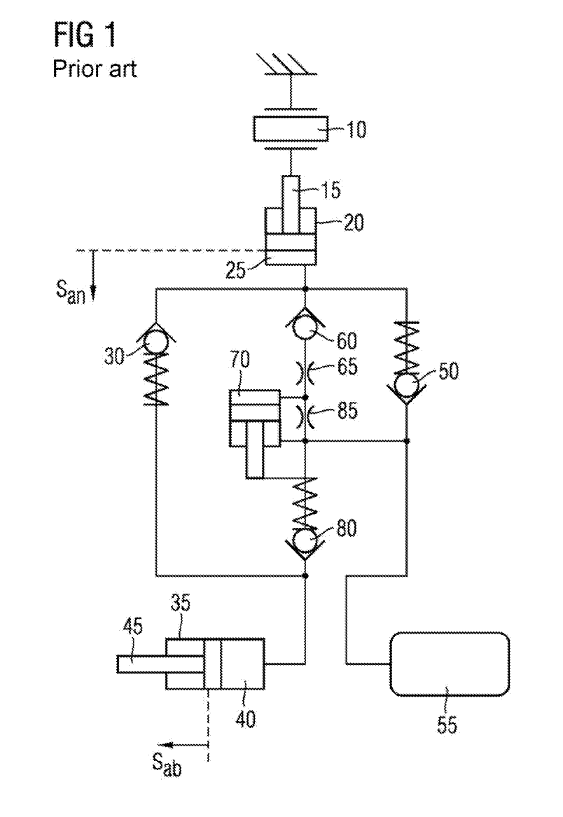

The hydraulic actuator 5 depicted in FIG. 1 includes a piezo actuator 10 that in terms of motion is linked to a drive piston 15 of a hydraulic drive cylinder 20.

The drive cylinder 20 includes a hydraulic drive volume 25 that is filled with hydraulic oil. The drive volume 25, by way of a stop valve 30 that opens at a sufficiently high opening pressure, is hydraulically linked to a hydraulic output cylinder 35. The stop vale 30 is correspondingly pretensioned. The output cylinder 35 at the drive side includes an output volume 40 that moves an output piston 45 that is located at the output side.

The drive volume by way of a stop valve 50 in a feeding-capable manner is linked to a reservoir 55.

The drive volume 25 by way of a stop valve 60 and a throttle 65 that in the flow direction is disposed behind the stop valve 60 may feed a pretension volume 70 of a hydraulic pretension cylinder 90, said throttle 65 by a pretension piston 75 controlling a pressure limiting valve 80. The pretension volume 70 by a second throttle 85 is linked to the reservoir 55. The pressure limiting valve 80 limits the pressure of the drive volume into the reservoir 55 or relieves the pressure of the drive volume in relation to the reservoir 55.

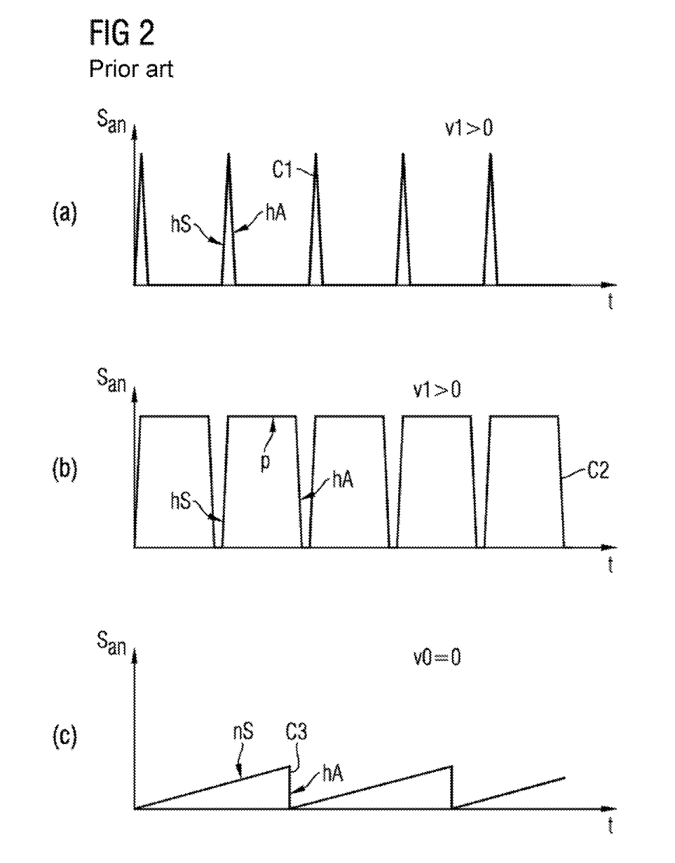

The hydraulic actuator 5 illustrated in FIG. 1 is operated as described hereunder: The individual operating modes are characterized by the actuation of the piezo actuator 10, as may be derived from the actuating travel/time diagrams (a), (b), and (c) according to FIG. 2, said diagrams being described in more detail hereunder.

In a first operating mode, the hydraulic actuator is operated by a low system rigidity and is actuated by an actuation velocity v1 that is not equal to zero.

The piezo actuator 10 is actuated as is diagrammatically shown by the curve C1 according to FIG. 2 (a): The piezo actuator 10 is rapidly deflected (e.g. the actuation path sₐₙ ascends at a steep gradient hS along with the time t). The pressure in the drive volume 25 of the drive cylinder 20 thus increases such that the stop valve 30 that links the drive volume 25 to the output volume 40, and the stop valve 60 that links the drive volume 40 to the pretension volume 70 are opened. Since the deflection of the piezo actuator 10 and thus the pressure increase in the drive volume 25 in this first operating mode are only very short, on account of the stop valve 60 that links the drive volume 25 to the pretension volume 70 almost no hydraulic oil may flow in the direction of the pretension volume 70 by virtue of the throttle 65 that is installed in series. The minimal flow of hydraulic oil runs off again into the reservoir 55 by way of the throttle 85 that links the pretension volume 70 to the reservoir Almost no pressure is thus built up in the pretension volume 70. The hydraulic oil consequently flows almost exclusively into the output volume 40 such that the output piston 45 is deployed by way of a resultant actuation path sₐb of the hydraulic actuator 5.

The deflection of the piezo actuator 10 subsequently is again abruptly reduced (steep negative gradient hA of the curve C1 in FIG. 2 (a)), on account of which the stop valve 30 that links the drive volume 25 to the output volume 40, and the stop valve 60 that links the drive volume 40 to the pretension volume 70 are closed. A negative pressure is created by virtue of the reduced hydraulic oil in the drive volume 25, on account of which the stop valve 50 that links the drive volume 25 to the reservoir 55 is opened and the missing hydraulic oil may flow from the reservoir 55 into the drive volume 25.

If the cycle, that is to say the rapid deflection and resetting of the piezo actuator 10, in the first operating mode is repeated, a continuous deflection of the output piston 45 is performed. If a counter force acts on the output piston 45, the pressure in the output volume 40 is increased according to the counter force and the hydraulic cross section of the output cylinder 35. Since the threshold in the pressure limiting valve 80 by virtue of the missing pressure in the pretension volume 25 is very low, hydraulic oil flows back from the output volume 40 by the pressure limiting valve 80 into the reservoir 55 already in the event of a minor counter force on the output piston 45.

In a second operating mode the hydraulic actuator 5 is operated by way of a high system rigidity and actuated at an actuation velocity V1 that is not equal to zero.

The piezo actuator 10 is actuated as is diagrammatically depicted by the curve C2 according to FIG. 2 (b). The piezo actuator 10 is rapidly deflected, as described above (e.g. the actuation path sₐₙ again ascends at a steep gradient hS along with the time t).

Accordingly, the pressure in the drive volume 25 is increased, and the stop valve 30 that links the drive volume 25 to the output volume 40, and the stop valve 60 that links the drive volume 40 to the pretension volume 70 are opened. The pressure in the drive volume 25 drops on account of the hydraulic oil flowing off into the drive volume 40, as in the previously described operating mode.

As opposed to the previous operating mode, the deflection of the piezo actuator 10 is kept constant for a specific time (cf. part p of the curve C2 according to FIG. 2 (b)). Since the stop valve 30 that links the drive volume 25 to the output volume 40 includes a defined opening pressure, the stop valve 30 is closed when the pressure differential between the drive volume 25 and the output volume 40 is smaller than the opening pressure of the stop valve 30. Since the piezo actuator 10 is still deflected, the remaining pressure bears on the stop valve 60 that links the drive volume 25 to the pretension volume. Since the stop valve 60 that links the drive volume 25 to the pretension volume 70 is not pretensioned, hydraulic oil may flow by way of the stop valve 60 and the throttle 65 that is disposed downstream of the stop valve 60 until the pressure differential between the pretension volume 70 and the drive volume 25 is greater. While a small part of the hydraulic oil does indeed flow back into the reservoir 55 again by way of the throttle 85 that links the pretension volume 70 to the reservoir 55, the pressure in the pretension volume 70 increases. On account thereof, the opening threshold in the pressure limiting valve 80 is increased.

After a specific time, the piezo actuator 10 is again abruptly reset to the original actuation path sₐₙ thereof (steep negative gradient hA of the curve C2 in FIG. 2 (b)). On account thereof, hydraulic oil is suctioned from the reservoir 55 into the drive volume 25, as in the case of the previously described first operating mode. Were the throttle 85 that links the pretension volume 60 to the reservoir 55 not installed, hydraulic oil would not only be suctioned from the reservoir 55 but also from the pretension volume 70.

The cycle described, that is the deflection and the resetting of the piezo actuator 10, is subsequently repeated. If a counter force acts on the output piston 45, the pressure in the output volume 40 is thus again increased. However, the threshold in the pressure limiting valve 80 by virtue of the increased pressure in the pretension volume 70 is higher than in the previously described operating mode, on account of which a higher force on the output piston 15 may be built up and an outflow of hydraulic oil from the output volume 40 is reduced. On account thereof, the system rigidity of the hydraulic actuator 5 is enhanced. The level of the rigidity is thus set by way of the actuation profile of the piezo actuator 10.

In a third operating mode, the hydraulic actuator 5 is operated at a high system rigidity and is not actuated (that is to say actuated at an actuation velocity v0=0).

To this end, the piezo actuator 10 is actuated as is diagrammatically depicted by the curve C3 according to FIG. 2 (c).

On account of the slow deflection (comparatively minor gradient nS) of the piezo actuator 10, the pressure in the drive volume 25 barely increases, on account of which only the stop valve 60 that links the drive volume 25 to the pretension volume 70 is opened, but not the stop valve 30 that links the drive volume 25 to the output volume. On account thereof, no hydraulic oil is pumped into the output volume 40 but only into the pretension volume 70, on account of which the threshold of the pressure limiting valve 80 and thus the system rigidity of the hydraulic actuator 5 increases without the output piston 45 being deflected.

After a specific time, the piezo actuator 10 is again abruptly reset to the original actuation path sₐₙ thereof (steep negative gradient hA of the curve C3 in FIG. 2 (c)).

In further embodiments (not illustrated in a dedicated manner) that otherwise correspond to the embodiment illustrated in FIGS. 1 and 2, an electro-dynamic actuator or an electro-magnetic actuator is present instead of a piezo actuator 10.

In further embodiments (not illustrated in a dedicated manner) hydraulic cylinders in the manner of bellows without pistons guided therein instead of hydraulic cylinders including pistons guided therein may also be provided for drive cylinders and/or output cylinders and/or pretension cylinders.

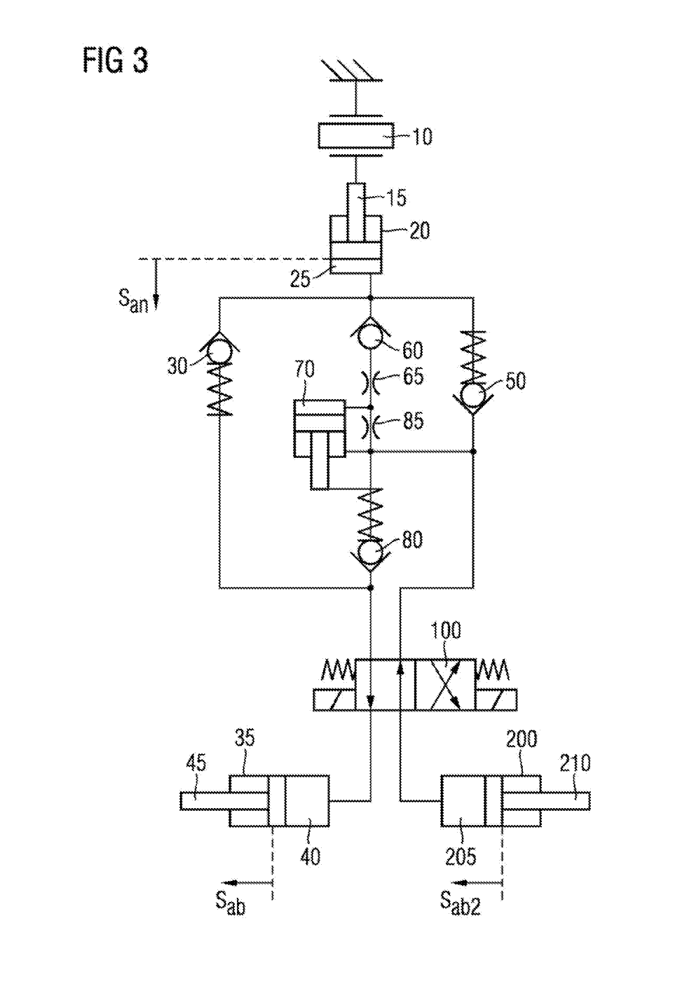

By contrast, the actuator illustrated in FIG. 3 includes a second output cylinder 200 instead of the reservoir 55. In a manner similar to the first output cylinder 35 described above, a second output volume 205 that drives the second output piston 210 is present in the second output cylinder 200.

The second output cylinder 200 consequently assumes the function of the reservoir of the examples described above. However, the second output piston 210 in the second output cylinder 200 additionally assumes the function of a further actuator component that in the embodiment depicted in FIG. 3 provides an output by way of an actuator path s_{ab2} in an output direction that is opposite to the output direction of the first output piston 45 of the first output cylinder 35 as described above. Consequently, the hydraulic actuator depicted in FIG. 3 is configured so as to actuate in mutually opposed directions.

In the case of the hydraulic actuator according to FIG. 3 the first output cylinder 35 and the second output cylinder 200 by a multi-port valve 100 are hydraulically linked collectively to the remaining part of the hydraulic actuator. The roles of the first output cylinder 35 and of the second output cylinder 200 that in a first position assumes the function of the reservoir 55 of the examples mentioned at the outset may be swapped by switching the multi-port valve 100; that is to say that the second output cylinder 200 in a first position of the multi-port valve assumes the role of the reservoir 55, while the first output cylinder 35 in a second position of the multi-port valve however assumes the role of a reservoir 55.

The hydraulic actuator depicted in FIG. 3 otherwise corresponds to the example hydraulic actuator depicted in FIG. 1.

The robot arm and the robot hand (not illustrated in a dedicated manner) include in each case one or a plurality of hydraulic actuators as described above, and include in each case one control device that actuates the piezo actuator 10 of each actuator depending on the required deflection velocity and the desired system rigidity.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A hydraulic actuator comprising:
a hydraulic drive cylinder comprising:
a drive piston guided in the hydraulic drive cylinder; and
a first hydraulic output cylinder hydraulically linked to the hydraulic drive cylinder and a pressure limiting valve that as a function of an action time of a force on the hydraulic drive cylinder, the drive piston, or the hydraulic output cylinder and drive piston in terms of pressure limits the first hydraulic output cylinder, wherein the pressure limiting valve is configured for limiting pressure in relation to a second output cylinder or for relieving pressure into the second output cylinder, and wherein the second output cylinder is hydraulically linked to the hydraulic drive cylinder.

2. The hydraulic actuator of claim 1, wherein the first output cylinder by way of a first pretensioned stop valve is linked to the hydraulic drive cylinder, and the second output cylinder by way of a second pretensioned stop valve is linked to the hydraulic drive cylinder, wherein the first pretensioned stop valve and the second pretensioned stop valve in relation to the drive cylinder include opposite blocking directions.

3. The hydraulic actuator of claim 1, wherein the first and the second output cylinder are hydraulically linked collectively by a multi-port valve.

4. The hydraulic actuator of claim 1, wherein the hydraulic actuator comprises a drive actuator that is linked to the drive cylinder or to the drive piston.

5. The hydraulic actuator of claim 1, wherein the drive actuator is a piezo actuator or an electro-dynamic or an electro-magnetic actuator.

6. The hydraulic actuator of claim 1, wherein the drive cylinder by way of a stop valve and of a first throttle is hydraulically linked to a pretension volume that is located in a pretension hydraulic cylinder comprises a pretension piston, wherein the pretension hydraulic cylinder or the pretension piston represents the pressure limiting valve.

7. The hydraulic actuator of claim 1, wherein the pretension volume by way of a second throttle is hydraulically connected to the second output cylinder.

8. A robot arm or robot hand comprising:
a hydraulic actuator comprising:
a hydraulic drive cylinder comprising:
a drive piston guided in the hydraulic drive cylinder; and
a first hydraulic output cylinder hydraulically linked to the hydraulic drive cylinder and a pressure limiting valve that as a function of an action time of a force on the hydraulic drive cylinder, the drive piston, or the hydraulic output cylinder and drive piston in terms of pressure limits the first hydraulic output cylinder, wherein the pressure limiting valve is configured for limiting pressure in relation to a second output cylinder or for relieving pressure into the second output cylinder, and wherein the second output cylinder is hydraulically linked to the hydraulic drive cylinder.

9. A method for operating a hydraulic actuator or a robot arm or a robot hand the method comprising:
deflecting at least one actuator for the duration of an operative or non-operative phase of the hydraulic actuator for a deflection duration at a deflection frequency;
establishing by the deflection duration a motional rigidity of the hydraulic actuator; and
establishing by the deflection frequency a resulting deflection velocity of the hydraulic actuator.

10. The method of claim 9, wherein a multi-port valve is actuated preferably for operating the hydraulic actuator in mutually opposed directions.
